(19) United States
(12) Patent Application Publication
(10) Pub. No.: US 2018/0133774 A1
(43) Pub. Date: May 17, 2018

(54) SYSTEM AND METHOD FOR BENDING METAL INCLUDING TANDEM PRESS BRAKES

(71) Applicant: Accurpress America Inc., Rapid City, SD (US)

(72) Inventors: Stephen HILTON, Rapid City, SD (US); Allen GUERNSEY, Rapid City, SD (US)

(73) Assignee: Accurpress America Inc., Rapid City, SD (US)

(21) Appl. No.: 15/814,221

(22) Filed: Nov. 15, 2017

Related U.S. Application Data
(60) Provisional application No. 62/422,578, filed on Nov. 15, 2016.

(51) Int. Cl. B21D 7/06; B21D 5/02; B30B 15/24

(52) U.S. Cl. CPC B21D 7/063; B21D 5/01; B30B 15/24; B21D 5/0263

(57) ABSTRACT

Two press brake machines each using a single, central hydraulic actuator are provided. The press brake machines are configured to operate separately or in tandem, depending upon a size of a sheet metal workpiece to be deformed. A locking device that may include an upper connecting block and a lower connecting block is provided on each of the at least two press brake machines to allow the machines to interlock when the machines are adjacent to one another and are operating in tandem. The upper connecting block may be “L” shaped to help provide the interlocking. Interlocking of the press brake machines during tandem operation helps prevent distortion that can occur in the upper and lower portions of the ram due to the press brake machine's use of a single, central hydraulic actuator.

### CROSS REFERENCE TO RELATED APPLICATIONS

This application claims priority to and the benefit of U.S. Provisional Patent Application No. 62/422,578, filed Nov. 15, 2016. The foregoing provisional application is incorporated by reference herein in its entirety.

### BACKGROUND

This application relates generally to press brakes and, in particular, a system that includes multiple press brakes that are linked to form a structure and mechanism for adjusting the length of a die.

A press brake machine or device is used as a tool to make precise bends in metal parts. Generally, a sheet of metal is placed within the machine and positioned precisely using a gauge. A punch, which often has the shape of a “V,” is placed against the metal sheet at the point where a bend is required. A punch is pressed into the metal sheet, which in turn is pressed into the die causing the sheet to bend. Frequently, the press brake machine is configured so that the die and the punch are long enough to contact the entire length or width of the sheet.

A press brake machine may be configured so that a forming die mounted on a bed may be “U” or “V” shaped. The die may include a pair of dies or half dies, for example. The distance between the dies may be adjusted so that the bearing areas for the metal part or workpiece being formed can be adjusted according to the forming requirements for the workpiece.

The bending of very large pieces of sheet metal often requires expensive, special press brake machines that rarely operate at full capacity, but require a lot of space (often unnecessarily). Thus, smaller press brake machines that are able to bend both shorter and longer components by operating separately or in tandem have become common over the years. However, press brake machines containing only a single, central hydraulic actuator or cylinder can pose problems when operating in tandem. In particular, when such press brake machines are operated in tandem, the load is not distributed equally across an upper beam or ram of each of the press brake machines, resulting in an outward distortion of the upper portion of the upper beams of the press brake machines, as well as an inward distortion of the lower part of the upper beams of the press brake machines.

### SUMMARY

An embodiment disclosed herein is a system that includes multiple press brakes that operation in tandem. As disclosed herein, a locking device is provided on the upper beams of each of the press brake machines that controls the distribution of the load across the upper beams. When multiple press brake machines are adjacent, locked, and operate in tandem, the locking device controls side deflection from off-center loading, and allows the multiple press brake machines to operate in sync and to perform as a single unit, while simultaneously preventing distortion in the upper beams of the press brake machines.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 is a front view of a separated pair of press brake machines.

FIG. 2 is a front view of the press brake machines of FIG. 1 shown in the adjacent position.

FIG. 3 is an expanded view of encircled area A shown in FIG. 2.

FIG. 4 is an expanded view of encircled area B shown in FIG. 2.

FIG. 5 is a front view of the press brake machines of FIG. 1 shown in the connected position.

FIG. 6 is an expanded view of encircled area F shown in FIG. 5.

FIG. 7 is an expanded view of encircled area D shown in FIG. 5.

### DESCRIPTION

Various features of the present invention will be described with reference to the drawings. Like numbers are used throughout the drawings to refer to the same or similar parts and in each of the embodiments of the invention hereafter described.

An exemplary press brake machine may include a ram or upper beam located above a bed. The machine may include a central, hydraulic actuator (e.g., a piston and cylinder) that forces the ram (and connected tool) downward toward the bed. Alternatively, the force of hydraulic pressure may be used to force the bed upward. In alternative embodiments, more than one hydraulic actuator may be provided.

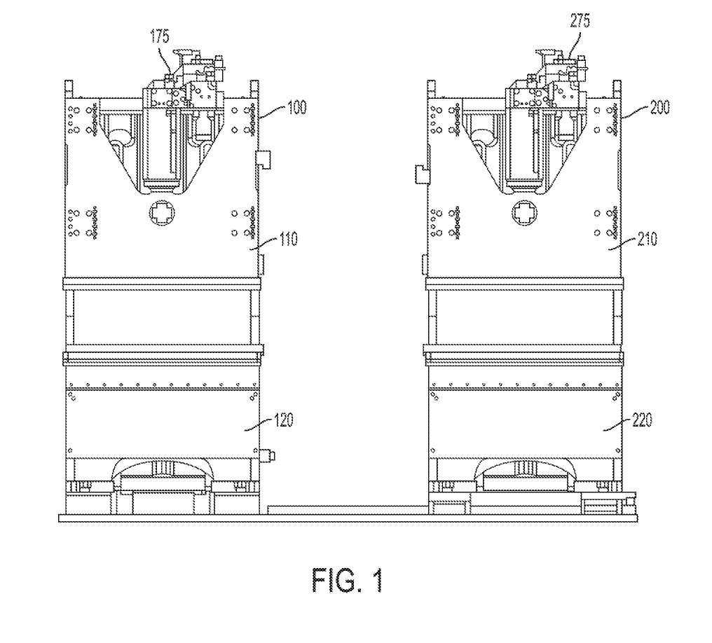

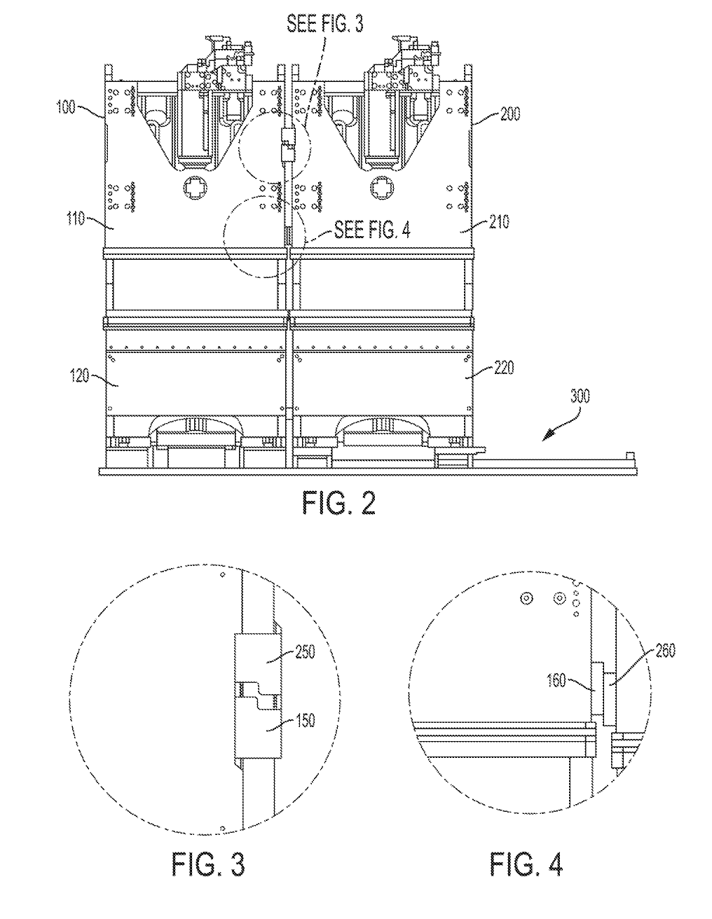

The press brake machine disclosed herein is used to bend or otherwise deform sheet-like workpieces, such as sheet metal workpieces. As shown in FIGS. 1 and 2, a press brake 100 has an upper beam 110 and a lower beam 120, at least one of which is movable toward and away from the other. Preferably, the upper beam is movable vertically, while the lower beam is fixed in a stationary position. A second press brake 200 likewise includes an upper beam 210 and lower beam 220. A tool for working the metal or workpiece may be mounted on each of the beams. For example, a male-forming punch and a female-forming die may be mounted on the upper and lower beams of the press brakes, respectively.

The punch has a downwardly-oriented, workpiece-deforming surface (or “tip”). The configuration of this surface is dictated by the shape into which it is desired to deform a workpiece. The die has a recess, bounded by one or more workpiece-deforming surfaces, that is aligned with the tip of the punch. The configuration of this recess corresponds to the configuration of the punch's tip. Thus, when the beams are brought together, a workpiece between them is pressed by the punch into the die to give the workpiece a desired deformation (e.g., a desired bend).

As shown in the figures, the lower beam or bed may include a base plate that supports a lower tool or die member 121, 221. Also, as shown in the figures, the press brakes may include a corresponding upper tool or punch 111, 211 that is mounted on the ram 110, 210 and moves downwardly between the die to bend the workpiece. The reference numerals indicate the general location of the ram and supporting frame structure.

The press brake may include a controller for controlling the bending of the workpiece and/or the movement of the various parts of the press brake including the upper ram. In addition, the controller may be configured to adjust the position of the workpiece along ten or more axes of motion through use of a backgage, for example. The use of a controller on the press brake provides for reduced time and improved efficiency of bending operations for even relatively simple bending of parts that include only two or three bends and for lots of parts that only include two or three parts.

The controller may include a display that, for example, provides the user with a graphical representation of the formed part in a simple to use format. The user may input various information such as, for example, the material type, thickness, and length, as well as information describing the bends and flange lengths. The controller may be configured to set the positions and speeds of all the axes of the machine. Thus, the controller reduces the setup time and operator experience required for bending various parts. In addition, the use of the controller may reduce the amount of scrap material that remains after the bending operation. The majority of controllable axes are found in the back gauge portion of the press brake which may include two or more fingers which act as material stops and supports that allow for accurate gauging (i.e., positioning) of flanges.

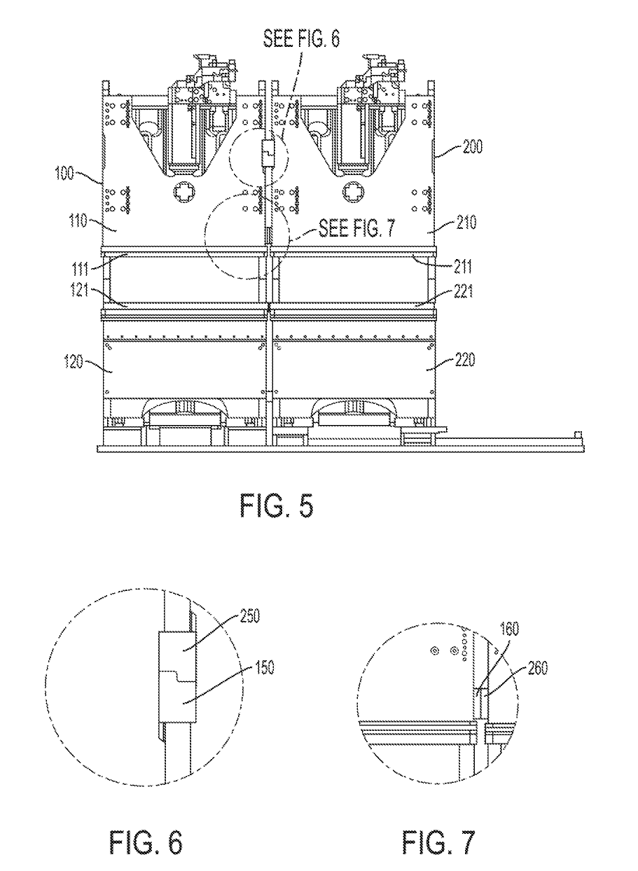

The press brakes 100, 200 are configured to be used in tandem and may be synchronized to operate together (see FIG. 5, for example). The press brakes 100, 200 are also configured to be operated as separate machines (see FIG. 1, for example). The tandem system employs Computer Numeric Control (CNC) to automate the operation of the press brakes using precisely programmed commands encoded on a control processor. Each machine may have a separate controller. The controllers may be linked together electronically and configured for tandem operation. Alternatively, one of the two controllers may be used to control both press brakes when the system is operated in tandem mode. In addition to one or more processors, each controller may include a storage medium, a display and an input terminal to receive operator commands. The CNC controllers may be configured to take into account many factors such as material length, material gauge, bending length and tool details. The controllers may be used to synchronize the press brakes to work in tandem and provide for automatic positioning of the back gauge, programming the practical bending sequence and other requirements of forming the proper shape of material.

As shown in the figures, each of the press brakes 100, 200 include a single centrally located actuator (e.g., a piston and cylinder) for driving the upper beam or ram 110, 210 downward toward the bed 120, 220. The rams 110, 210 are configured to slide on vertical and linear tracks, rails or ways that maintain the ram in stable position. The hydraulic actuator 175, 275 for driving movement of the ram of each of the press brakes may be configured in a conventional manner. Thus, for example, any suitable hydraulic actuator driving system may be utilized in the tandem press brake system disclosed herein.

The forces associated with the metal bending process causes significant stresses within the various parts of the press brake machines associated framing. For example, with the single centrally located hydraulic actuator driven press brakes disclosed herein, there is a tendency for the bottom portion of the ram and supporting frame structure to be distorted outwardly (i.e., away from the middle of the upper beam) during the bending operation. At the same time, the upper portion of the ram and supporting frame structure tends to move inwardly (i.e., towards the middle of the upper beam). Thus, when the press brakes are operated in tandem there is the possibility of misalignment or deformation of the rams (and associated tooling) of the two press brakes (especially at the boundary where the press brakes meet), even though computer controls are used to synchronize the operation of the rams. The system disclosed herein provides for a linking or interlocking between the two press brakes to provide for improved tandem operation of the press brakes.

At least one of the press brakes 100, 200 may be mounted on a support structure that facilitates movement of one of the press brakes. For example, as shown in FIGS. 1 and 2, the right side press brake 200, may be mounted on a rail system 300 that allows the press brake to slide to a position immediately adjacent to the left side press brake 100. The press brake 200 may be locked in position after the sliding movement is completed. Alternative structures to facilitate movement of the press brake 200 may be provided. For example, the press brake may be mounted on a rolling or rotating base structure.

Each of the press brakes 100, 200 may include a pair of upper and lower connecting blocks. The upper blocks 150, 250 are connected to an upper portion of the press brake downward moving ram. As shown in FIG. 3, the upper connecting blocks 150, 250 are “L” shaped to provide for interlocking. Other suitable shapes could be used, for example any shapes provide a tongue and groove type interlocking. The blocks may be connected to a suitable part of the frame structure to transfer force between the press brakes. The blocks are preferably bolted to the ram structure. The lower connecting blocks 160, 260 are connected to a lower portion of the press brake ram and, when the rams are operated in tandem, abut against each other. The upper and lower connecting blocks can be configured to be an aftermarket or add on feature for existing press brakes so that, when coupled with a suitably configured controller(s), existing press brake machines may be adapted for tandem use.

When tandem operation is desired, the press brakes are positioned adjacent to each other by, for example, sliding the right side press brake 200 to the left as shown in FIGS. 1 and 2, for example. Prior to tandem operation, the upper connecting blocks 150, 250 are initially not aligned. However, the position of the rams are adjusted (e.g., the right side ram 210 is moved upwardly) so that the connecting blocks are interlocked as shown in FIG. 6. When the press brakes are operated in tandem using the computer controls, the upper connecting blocks 150, 250 experience lateral forces tending to separate the blocks as the upper portion of the press brakes experience deforming forces during the bending operation. The interlocking shape of the blocks prevent separating movement of the upper portion of the press brakes and provides for the position of the rams to stay aligned.

The lower connecting blocks 160, 260 are shown in an aligned state for tandem operation in FIG. 7. During the tandem operation of the press brakes, the lower portion of the ram and supporting structure causes the lower blocks 160, 260 to be forced together. The blocks resist the movement of the press brakes providing for alignment of the rams during tandem operation.

The connecting blocks transfer any bending moment that occurs in the rams, resulting in improved alignment and, therefore, improved tandem operation of the press brakes. The upper connecting blocks 150, 250 transfer a separating or tensile force and the lower connecting blocks 160, 260 transfer a connecting or compressive force.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described are considered to be within the scope of the invention.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” “mounted” and the like as used herein to mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “fore,” “aft,” “inboard,” “outboard,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the press brake shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A system for bending metal workpieces comprising:
at least two press brake machines, wherein each press brake machine includes:
an upper beam;
a lower beam;
an upper tool mounted on the upper beam;
a lower tool mounted on the lower beam;
a locking device;
a central hydraulic actuator that is configured to drive the upper beam vertically downward towards the lower beam; and
a controller configured to control the at least two press brake machines, wherein
wherein at least one of the at least two press brake machines is mounted on a support structure, the support structure facilitating movement of the at least one press brake machine to a position adjacent to the other of the at least two press brake machines;
wherein the at least two press brake machines are configured to be locked together by the locking device when the at least two press brake machines are positioned adjacent to one another; and
wherein each of the locking devices is configured to transfer a distorting force that occurs in the upper beam of each of the at least two press brake machines when the at least two press brake machines are locked together and are being used in tandem.

2. The at least two press brake machines according to claim 1, wherein the upper beam is configured to move vertically.

3. The at least two press brake machines according to claim 1, wherein the lower beam is fixed in a stationary position.

4. The at least two press brake machines according to claim 1, wherein
the upper tool includes a punch for deforming the workpiece; and
the lower tool includes a die having a recess that is aligned with the workpiece deforming surface.

5. The at least two press brake machines according to claim 1, wherein the controller in each of the at least two press brake machines is configured to operate separately.

6. The at least two press brake machines according to claim 1, wherein
each of the controllers is configured to be electronically linked to the other controller and to operate in tandem with the other controller of the other of the at least two press brake machines.

7. The at least two press brake machines according to claim 6, wherein one of the controllers of the at least two press brake machines is configured to control both of the at least two press brake machines.

8. The at least two press brake machines according to claim 1, wherein the support structure is one of a rail system, a rolling base structure, or a rotating base structure.

9. The at least two press brake machines according to claim 1, wherein the locking device includes an upper connecting block.

10. The at least two press brake machines according to claim 9, wherein the locking device further includes a lower connecting block.

11. The at least two press brake machines according to claim 10, wherein
the upper connecting block is L-shaped; and
the upper connecting block of each of the at least two press brake machines are configured to interlock the at least two press brake machines.

12. The at least two press brake machines according to claim 10, wherein the lower connecting block of each of the at least two press brake machines abut one another when the at least two press brake machines are adjacent to one another and locked together.

13. The at least two press brake machines according to claim 10, wherein the upper connecting block and the lower connecting block are located on the upper beam of each of the at least two press brake machines.

14. The at least two press brake machines according to claim 11, wherein when the at least two press brake machines are adjacent to one another, a position of the upper beam of at least one of the at least two press brake machines is adjusted to allow the upper connecting block from each of the at least two press brake machines to interlock.

15. The at least two press brake machines according to claim 14,
wherein the upper connecting block, when interlocked with the upper connected block of the adjacent press brake machine, transfers a tensile force that occurs in the upper beam of each of the at least two press brake machines, respectively;
wherein the lower connecting block, when in abutment the lower connecting block of the adjacent press brake machine, transfers a compressive force that occurs in the upper beam of each of the at least two press brake machines, respectively; and
wherein the transfer of the tensile force and the compressive force results in improved alignment of the at least two press brake machines.

16. A method for equally distributing a load across an upper beam of at least two press brake machines that are locked together in tandem and that operate in sync, each of the at least two press brake machines further including a lower beam, a male-forming punch mounted on the upper beam, a female-forming die mounted on the lower beam, a locking device, a central hydraulic cylinder that drives the upper beam vertically downward towards the lower beam, and a controller configured to control the at least two press brake machines, wherein each of the press brakes machines are mounted on a support structure, the method comprising the steps of:
moving the at least one of the at least two press brake machines on the support structure to a position adjacent to the other of the at least two press brake machines; and
locking the at least two press brake machines together, using the locking device, when the at least two press brake machines are positioned adjacent to one another, such that distorting forces that occur in the upper beam of each of the at least two press brake machines when the at least two press brake machines are locked together and are being used in tandem is transferred.
